(19) United States
(12) Patent Application Publication
(10) Pub. No.: US 2019/0106307 A1
(43) Pub. Date: Apr. 11, 2019

(54) Depth Compensated Motion Compensation Method

(71) Applicant: Benton Frederick Baugh, Houston, TX (US)

(72) Inventor: Benton Frederick Baugh, Houston, TX (US)

(21) Appl. No.: 15/726,131

(22) Filed: Oct. 5, 2017

(51) Int. Cl. B66D 1/52; B66D 1/60; B63B 27/08

(52) U.S. Cl. CPC B66D 1/52; B63B 43/06; B63B 27/08; B66D 1/60

(57) ABSTRACT

The method of providing depth compensated motion compensation proximate a subsea landing package to isolate heaving motion of the supporting vessel from the supported subsea landing package, comprising a supporting cylinder for connecting to the subsea landing package having a first cross sectional area exposed to environmental pressure with a resulting first force, a second and opposing cross section area exposed to environmental pressure providing a second and opposing balancing force, a piston within the cylinder with compressed gas in a first chamber on a first side of the piston and a low pressure gas or a vacuum is in a second chamber on the opposite side of the piston, and adjusting the gas pressure in the first chamber acting on the piston such that the force acting on the piston is approximately the in water buoyed weight of the subsea landing package.

### TECHNICAL FIELD

This invention relates to the method of providing motion compensation to equipment being landed on the seafloor utilizing depth compensated components proximate the subsea location.

### BACKGROUND OF THE INVENTION

When equipment is landed on the seafloor, it characteristically is supported from a vessel at the surface which tends to heave with the waves and swells of the ocean. This means that the motion of the vessel will tend to be duplicated in the subsea equipment at the time of landing as lifting cables or pipes are relatively stiff. For example, if the vessel is moving up and down about five feet, the subsea landing package will be moving up and down five feet also.

The packages to be landed can vary from a few hundred pounds to a few million pounds. As there are frequently connecting interfaces between the package to be landed and the package to be landed on, the package to be landed can impact the package to be landed on several times as it is slowly landed in place. This can be very damaging to connecting interfaces.

Several methods have been tried to solve this problem including actively powering a supporting winch in and out in opposite timing with the vessel motion. This can be done when the supporting means is a steel cable, but becomes more complex as the package gets heavier and must be done on every winch to be used. The steel cable is relatively good for this service as being bent repeatedly across a sheave during a process like this has minimal effect on its service life.

When the supporting means is a steel pipe, especially a pipe called coiled tubing, repeated yielding of the pipe around a sheave under tension is very damaging to the service life of the steel pipe. Characteristically the wire rope and steel pipe wrap around a spool and go over a single sheave to change its direction to vertical as it goes into the ocean. As the ocean depths increase, the weight of the steel cable or pipe adds up and limits the amount of load which can be handled. In one case in 6,000 feet of water, 75% of the capacity of the wire rope was consumed in just holding the wire rope up. Only 25% of the rating was available to do useful work.

Newer synthetic ropes are advantageous to be used in the service as they are near neutrally buoyant. What this means is the approximately 100% of the capacity of the synthetic rope is available for lifting capacity. However, a synthetic rope winch is very different from a steel cable winch when requiring multiple layers and high capacity. Repeated high-tension wraps of synthetic rope tend to “knife” the upper layers into the lower layers and damage the synthetic rope. What is the normal “winch” becomes a light duty storage reel and the tension is taken by a different kind of winch. The synthetic rope winch will comprise two parallel drums with at least six grooves in each one. The synthetic rope is wrapped around one and then the other in grooves successively and will end up having six oval loops around the two drums. The repeated wrapping around the drums will accumulate enough friction so that the synthetic rope will be able to take a load. U.S. Pat. No. 8,322,691 gives a description of one of these winches.

As the synthetic rope comes off the storage spool onto the first drum it will have a very low load, e.g. 500 lbs. on a large system. As it exits the last groove on the second drum if will be under full tension, e.g. 2,000,000 lbs. One foot of synthetic rope under 500 lbs. tension can be twelve and one-half inches long under 2,000,000 lbs. tension. That means the cable is moving faster when it exits the synthetic rope winch than when it enters by about 4%. Said another way, the synthetic from in the last groove is moving 4% faster than the synthetic rope in the first groove. All the grooves are in the same drums, so they are all moving at the same speed. This means that the synthetic rope is constantly sliding a little bit in the grooves. This means the operation is somewhat inefficient and the sliding friction generates a little heat. This heat is not of a consequence in normal operations.

However, when a synthetic rope winch is used for motion compensation service, the area of this repeated sliding friction is relatively short. This means heat buildup which can be serious and can potentially destroy the synthetic rope and cause the load to be dropped. For this reason, a better solution needs to be available for synthetic rope winches.

A new approach has been needed for the motion compensation of packages landed in a subsea environment as long as packages have been landed. This need has been amplified over the past 60 years when progressively larger and heavier packages have been required to be stacked on the ocean floor with critical interface connections. The use of synthetic rope has made the need more pressing.

### BRIEF SUMMARY OF THE INVENTION

The object of this invention is to provide a method for motion compensation of subsea landing packages.

A second object of this invention is to provide a method for motion compensation of subsea landing packages which will work with steel cable, steel pipe, or synthetic rope.

A third objective of this invention is to provide a method for motion compensation of subsea landing packages which will work with conventional winches or synthetic rope winches, especially with pre-existing winches.

Another objective of this invention is to provide a method for motion compensation of subsea landing packages which does not require modification of the winches.

Another objective of this invention is to provide a method for motion compensation of subsea landing packages which is compensated for the depth to be landed.

### BRIEF DESCRIPTION OF DRAWINGS

FIG. 1 is a view of an offshore vessel using the features of this invention

FIG. 2 is a quarter section of a depth compensated motion compensation cylinder in a mid-stroke condition.

FIG. 3 is the same image as Fig., repeated for reference.

FIG. 4 is the depth compensated motion compensation cylinder of FIG. 2 and FIG. 3 shown at the end of its stroke when the vessel has heaved downwardly.

FIG. 5 is the depth compensated motion compensation cylinder of FIG. 2 and FIG. 3 shown at the end of its stroke when the vessel has heaved upwardly.

### DETAILED DESCRIPTION OF THE INVENTION

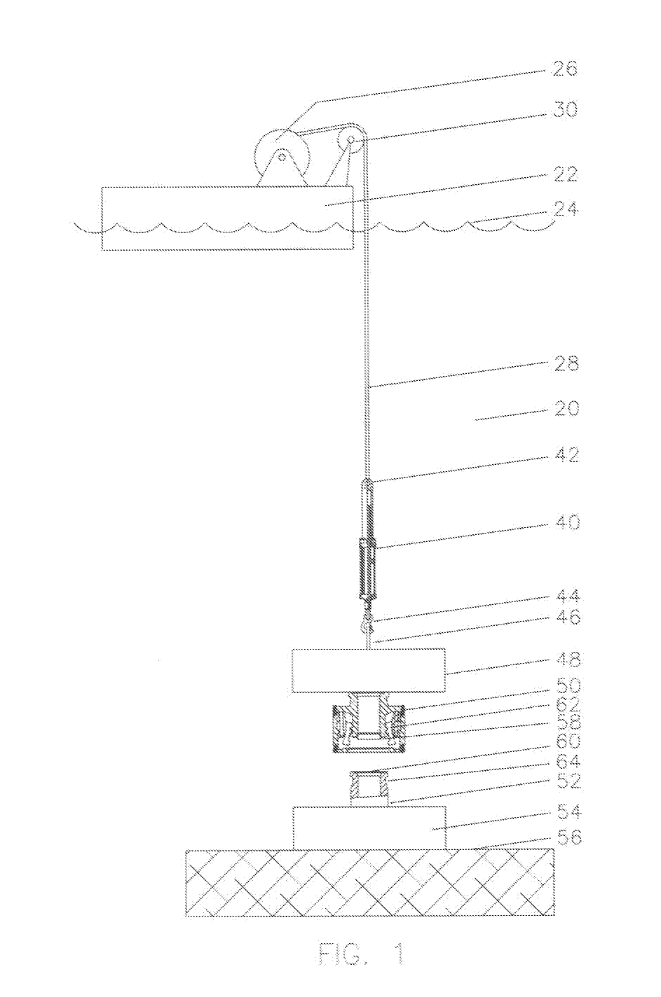

Referring now to FIG. 1, a view of a system 20 for landing subsea landing packages is shown with vessel 22 on ocean surface 24, winch 26 on vessel 22 supporting cable 28. Sheave 30 is illustrative of a single groove sheave for changing the direction of supporting cable 28 from approximately horizontal to vertical. Supporting cable 28 can be wire rope, steel pipe, synthetic rope, or similar flexible, elongated members. Sheave 30 can also be considered illustrative of a dual drum synthetic rope winch as seen in U.S. Pat. No. 8,322,691.

Depth compensated cylinder 40 is connected to supporting cable 28 at 42 and has attachment hook 44 illustrated as connecting to padeye 46 on subsea landing package 48. Subsea landing package 48 comprises one or more connectors 50 which will engage one or more mandrels 52 on seafloor package 54 which is landed on seafloor 56. One or more connectors 50 comprise a seal ring 58 which will engage seal surface 60 on mandrel 52. Locking dogs 62 will engage locking grooves 64 on mandrel 52 to secure subsea landing package 48 to seafloor package 54.

Connectors such as 50 can be expected to contain high loads often over one million pounds and high pressures up to fifteen thousand p.s.i, and so can be finely machined and polished interface surfaces. If a two million-pound subsea landing package comes down and repeatedly hammers the interface surfaces due to surface vessel motions, there is a high probability that significant damage can occur. Therefore, the subsea landing package needs to be motion compensated against the vessel motion. Prior art would have attempted to do this motion compensation at the surface by dynamically and reversibly driving the winches or with surface cylinder arrangements to move the sheave 30.

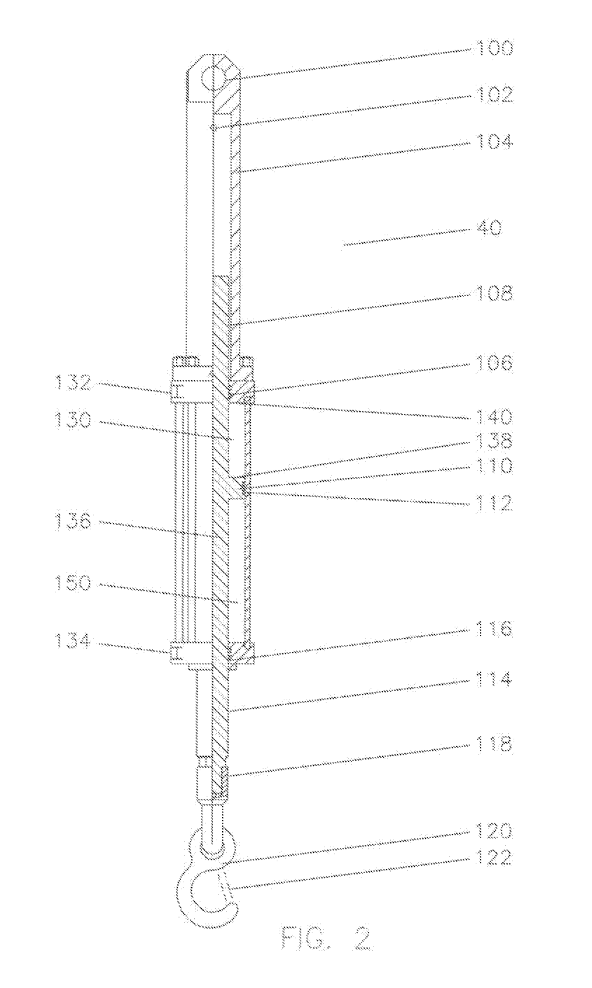

Referring now to FIG. 2 depth compensated cylinder 40 is shown illustrated as having a hole 100 for attachment at the top, a vent hole 102, an upper cylindrical section 104, upper rod seals 106, upper rod 108, piston 110, piston seals 112, lower, lower rod 114, lower rod seals 116, threaded attachment 118, hook 120 and hook safety latch 122.

Chamber 130 is connected to a vacuum pump at port 132, a vacuum is drawn and then the port 132 is plugged, or a connected valve is closed. As a practical matter, port 134 can be pressured to move piston assembly 136 up until shoulder 138 contacts shoulder 140 and the vast majority of air will be expelled from chamber 130, making it for all practical purposes a vacuum when the piston assembly 136 moves back down to an intermediate position.

Chamber 150 is filled with enough inert gas, such as nitrogen, that when the piston 110 is moved approximately to the position as shown which chamber 130 being twice as long as chamber 150 and the resulting force on the piston is equal to the weight of the subsea landing package when it is underwater. This can involve some extensive calculations and predictions as to what the subsea landing package 48 will weigh when it is underwater.

Upper rod 108 and lower rod 114 are approximately of the same diameter and are both exposed to the environmental or seawater pressure at all times. This means that the environmental or seawater pressure is balanced at all times and its effects are cancelled, or it is “depth compensated”. This would be contrasted to a cylinder with only a single rod (i.e. having no upper rod), and the environmental or seawater pressure on the single rod end would be acting to collapse the cylinder at all times.

This means that chamber 150 of the depth compensated cylinder 40 can be charged with approximately the right pressure or even no pressure at all when the subsea landing package 48 is picked up off the deck of the vessel 22. When the subsea landing package 48 is lowered off the side of the vessel 22 and is below the surface of the ocean 24, the pressure in chamber 150 can be adjusted to position the piston 110 in the nominal or central motion compensation position. As the effect of the seawater is cancelled out, the subsea landing package 48 will be motion compensated at whatever the depth it is lowered. The subsea landing package 48 cannot effectively be motion compensated until it is underwater as its effective weigh changes due to buoyance when lowered into the water.

Referring to FIG. 3, the same image of FIG. 2 is repeated in the central or nominal motion compensation position.

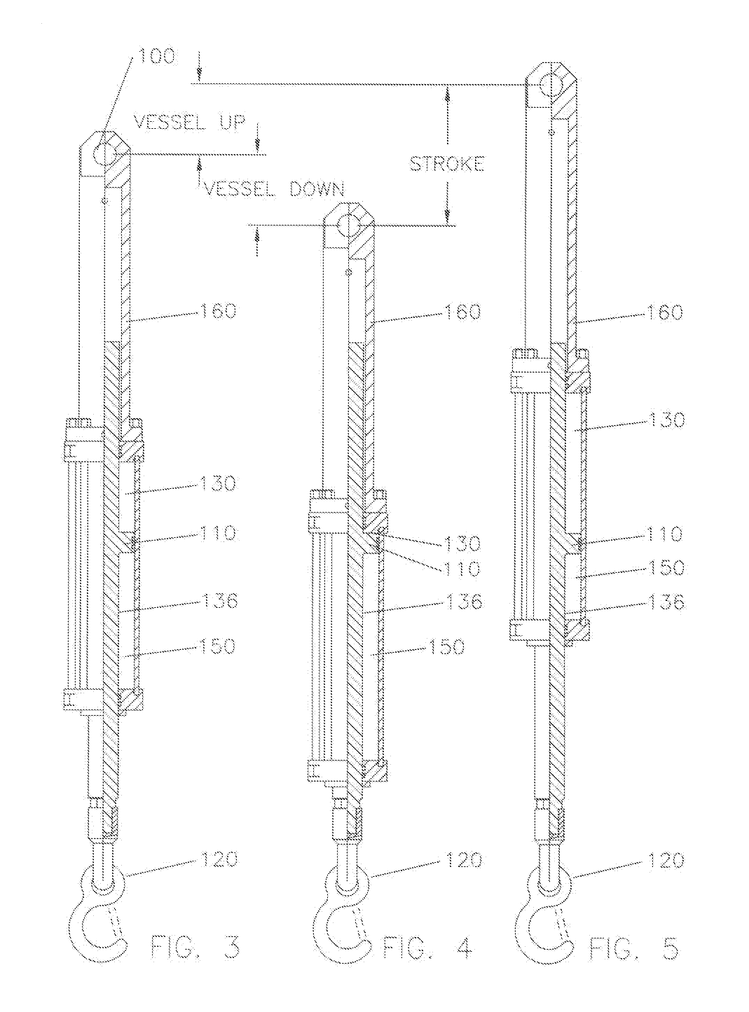

Referring now to FIG. 4, the hook 120 and piston assembly 136 are shown in the same vertical location. The other parts of the cylinder 160 are shown to be down to the point that piston 110 is at the end of chamber 130, which is the extent of the distance the vessel can move down under motion compensation. The pressure in the compressed gas in chamber 150 is reduced due this chamber size expansion.

Referring now to FIG. 5, the hook 120 and piston assembly 136 are shown in the same vertical location. The other parts of the cylinder 160 are shown to be up to approximately the same distance as they were down in FIG. 4, which is generally the extent of the distance the vessel can up down under motion compensation. The pressure in the compressed gas in chamber 150 is increased due this chamber size reduction.

These increases and reduction of the pressure in chamber 150 impact the quality of the motion compensation movement directly in proportion to the changes in pressure. A longer chamber 150 will tend to minimize the changes in pressure for the same strokes, but causes expensive polished bore cylinders to become longer. A second solution to this is to add a simple gas tank to the outlet 134. This gives reduced changes in pressure with the same cylinder length.

As can be readily appreciated, a variety of connection methods can be implemented between the depth compensation cylinder 40 and the support cable 28. Similarly, alternate connections can be provided between the depth compensated cylinder, including making the depth compensated cylinder 40 an integral part of the subsea landing package 48.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

### SEQUENCE LISTING

N/A

That which is claimed is:

1. The method of providing depth compensated motion compensation to isolate the heaving motion of a supporting vessel at the ocean surface from a subsea landing package being landed in ocean waters and being supported from said supporting vessel by a supporting cable, comprising
providing a compensating cylinder proximate said subsea landing package having rod ends exposed to environmental pressure on opposite ends, providing a piston within said compensating cylinder with compressed gas is in a first chamber on a first side of said piston and a low pressure gas or a vacuum in a second chamber on the opposite side of said piston,
providing a first connection on said compensating cylinder to said supporting cable which extends up to said supporting vessel or to said subsea landing package,
providing a second connection on said compensating cylinder rod to the other of said supporting cable which extends up to said supporting vessel or to said subsea landing package, and
adjusting the gas pressure in said first chamber acting on said piston such that the force acting on said piston is approximately the in water buoyed weight of said subsea landing package.

2. The method of claim 20 further comprising said adjusting of said gas pressure in said first chamber after said subsea landing package is underwater.

3. The method of claim 20 further comprising said adjusting of said gas pressure in said first chamber on the deck of said supporting vessel.

4. The method of claim 1 further comprising connecting a gas bottle to said first chamber to expand the volume of said compressed gas.

5. The method of claim 1 further comprising said supporting cable is a wire rope, synthetic rope, pipe, tubing, or the such like.

6. The method of claim 1 further comprising said connection to said subsea landing package is a remotely operated connector.

7. The method of providing depth compensated motion compensation proximate a subsea landing package for a subsea landing package supported from by surface vessel and one or more cables to isolate said subsea landing package from the heaving motion of said supporting vessel, comprising
providing a compensating cylinder with a central piston and cylinder rods on each end which are exposed to environmental pressures to cancel the effect of environmental pressure and being connected on a first end to said one or more cables and on the other end to said subsea landing package.
connecting said one or more cables from said surface vessel to one end of said compensating cylinder and connecting the other end of said compensating cylinder to said subsea landing package,
providing a piston within said compensating cylinder with compressed gas in a first chamber on a first side of said piston and a low pressure gas or a vacuum in a second chamber on the opposite side of said piston, and
adjusting the gas pressure in said first chamber acting on said piston such that the force acting on said piston is approximately the in water buoyed weight of said subsea landing package.

8. The method of claim 7 further comprising said adjusting of said gas pressure in said first chamber after said subsea landing package is underwater.

9. The method of claim 7 further comprising said adjusting of said gas pressure in said first chamber on the deck of said supporting vessel.

10. The method of claim 7 further comprising connecting a gas bottle to said first chamber to expand the volume of said compressed gas.

11. The method of claim 7 further comprising said supporting cable is a wire rope, synthetic rope, pipe tubing, or the such like.

12. The method of claim 7 further comprising said connection to said subsea landing package is a remotely operated connector.

13. The method of claim 7 further comprising said connection to said subsea landing package is a fluid pressure actuated connector.

14. The method of providing depth compensated motion compensation for a subsea landing package to isolate heaving motion of the supporting vessel from a subsea landing package supported by a supporting cable from said supporting vessel, comprising
a compensating cylinder for connecting to said subsea landing package, said compensating cylinder and having a first cross sectional area exposed to environmental pressure with a resulting first force, a second and opposing cross section area exposed to environmental pressure providing a second and opposing balancing force, a piston within said compensating cylinder having compressed gas in a first chamber on a first side of the piston and having a low pressure gas or a vacuum is in a second chamber on the second side of the piston,
said compensating cylinder being proximate said subsea landing package and
adjusting the gas pressure in said first chamber acting on the piston such that the force acting on the piston is approximately the in water buoyed weight of the subsea landing package.

15. The method of claim 14 further comprising said adjusting of said gas pressure in said first chamber after said subsea landing package is underwater.

16. The method of claim 14 further comprising said adjusting of said gas pressure in said first chamber on the deck of said supporting vessel.

17. The method of claim 14 further comprising connecting a gas bottle to said first chamber to expand the volume of said compressed gas.

18. The method of claim 14 further comprising said supporting cable is a wire rope, synthetic rope, pipe, tubing, or the such like.

19. The method of claim 14 further comprising said connection to said subsea landing package is a remotely operated connector.

20. The method of claim 14 further comprising said connection to said subsea landing package is a fluid pressure actuated connector.
